(19) United States
(12) Patent Application Publication
(10) Pub. No.: US 2004/0247116 A1
(43) Pub. Date: Dec. 9, 2004

(54) Method of generating a stream cipher using multiple keys

(76) Inventors: Stephen Laurence Boren, Vancouver (CA); Andre Jacques Brisson, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/773,959

(22) Filed: Feb. 9, 2004

Related U.S. Application Data
(63) Continuation-in-part of application No. PCT/CA03/01538, filed on Nov. 20, 2002.
Application No. PCT/CA03/01538 is a continuation-in-part of application No. 10/299,847, filed on Nov. 20, 2002.

(51) Int. Cl. H04K 1/04

(52) U.S. Cl. 380/37

(57) ABSTRACT

In symmetric methods of encryption the stream cipher should be as long as the plaintext message. Such a cipher is difficult to generate if the plaintext data to be encrypted is enormous. The present invention provides a method of generating a stream cipher of variable length which may be extremely long. It is generated by creating a number of random sub-keys having non-repeating lengths and combining such sub-keys in a random way.

### CROSS-REFERENCE TO RELATED APPLICATIONS

This application is a continuation-in-part of U.S. patent application Ser. No. 10/299,847 filed Nov. 20, 2002, which is pending, and international application no. PCT/CA03/01538 designating the United States, which is pending.

### TECHNICAL FIELD

The invention relates to the field of encryption methods and more particularly to a method of generating a stream cipher to encrypt electronic communications which may be extremely long.

### BACKGROUND ART

Various methods of encryption to provide secure electronic communications are well known in the art. In symmetric methods of encryption, the sender and the recipient use the same code or key to encrypt and decrypt the message. The only completely secure cipher which cannot possibly be broken or deciphered is the One-Time Pad (OTP). A OTP takes a stream of bits that contains the plaintext message, and a secret random bit-stream of the same length as the plaintext (the key). To encrypt the plaintext with the key, each pair of bits from the key and plaintext is sequentially acted on by the exclusive-or function to obtain the ciphertext bit. The ciphertext cannot be deciphered if the key is truly random and the key is kept secret from an unauthorised party. The problem with this method is that the key should be at least the same length as the message. If a shorter key is used and repeated then the cipher can be broken. In some cases the data which needs to be encrypted is extremely large.

There is therefore a need for a method of generating a random key, or OTP, which is of variable length and that allows for encryption of very large amounts of data.

### DISCLOSURE OF INVENTION

The present invention therefore provides a method of generating a stream cipher having length×bytes, the method comprising the steps of i) selecting a number n of sub-keys each having a unique non-repeating length mₙ bytes; ii) generating n random numbers, one for each sub-key, each having length mₙ bytes; iii) generating a n+1st random number R; iv) set p=Modmₙ(R); v) for each byte whose position in the nth random number is p applying a function to all n bytes to generate a value; vi) concatenating the value to the end of the stream cipher; vii) set p=p+1; and viii) repeating step v), vi) and vii) until the stream cipher is x bytes in length. Preferably the selected length m of each sub-key is a prime number. The method may also include the further step of applying a delinearization function to the stream cipher.

According to one aspect of the invention, each of the n random numbers is generated by: i) generating a n+2nd random number which is not a perfect square; ii) calculating the square root of the n+2nd random number; iii) generating a n+3rd random number; iv) commencing with a digit whose position in the n+2nd random number is calculated based on the n+3rd random number, taking finite strings of digits sequentially and converting each finite string into a byte; v) concatenating each byte sequentially until the selected length mₙ of said each of the n random numbers has been reached.

The invention further provides a computer program product, an article for carrying out the method, and a data processing system for carrying out the method.

### BRIEF DESCRIPTION OF DRAWINGS

In drawings which disclose a preferred embodiment of the invention:

FIG. 1 is a schematic illustration of a computer system for carrying out the method of the invention; and

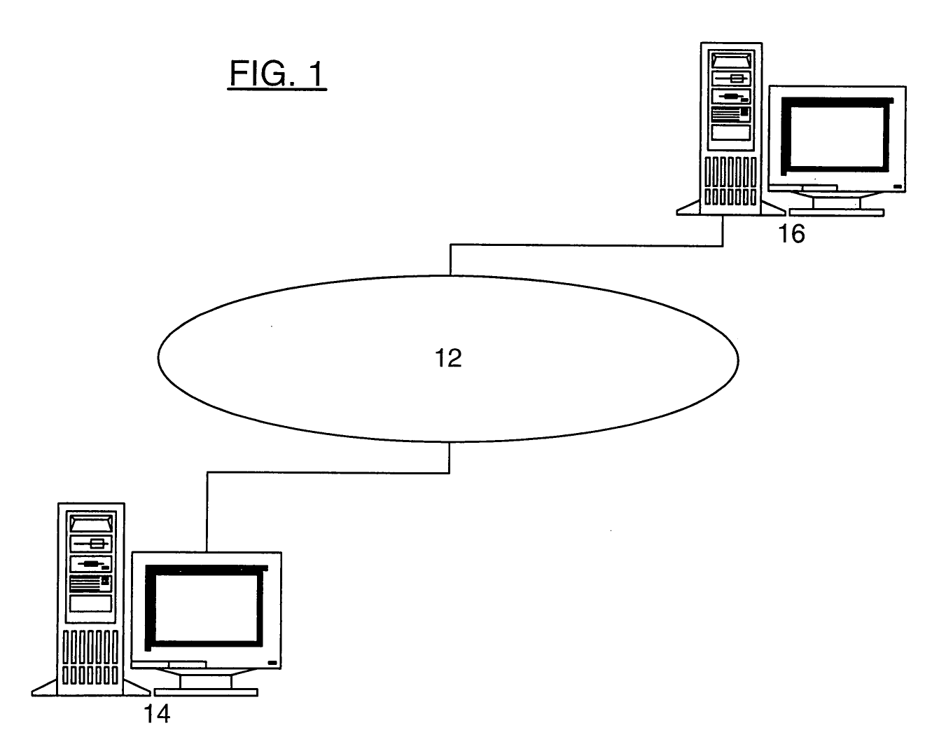

FIG. 2 is a flow chart illustrating the method of the invention.

### BEST MODE(S) FOR CARRYING OUT THE INVENTION

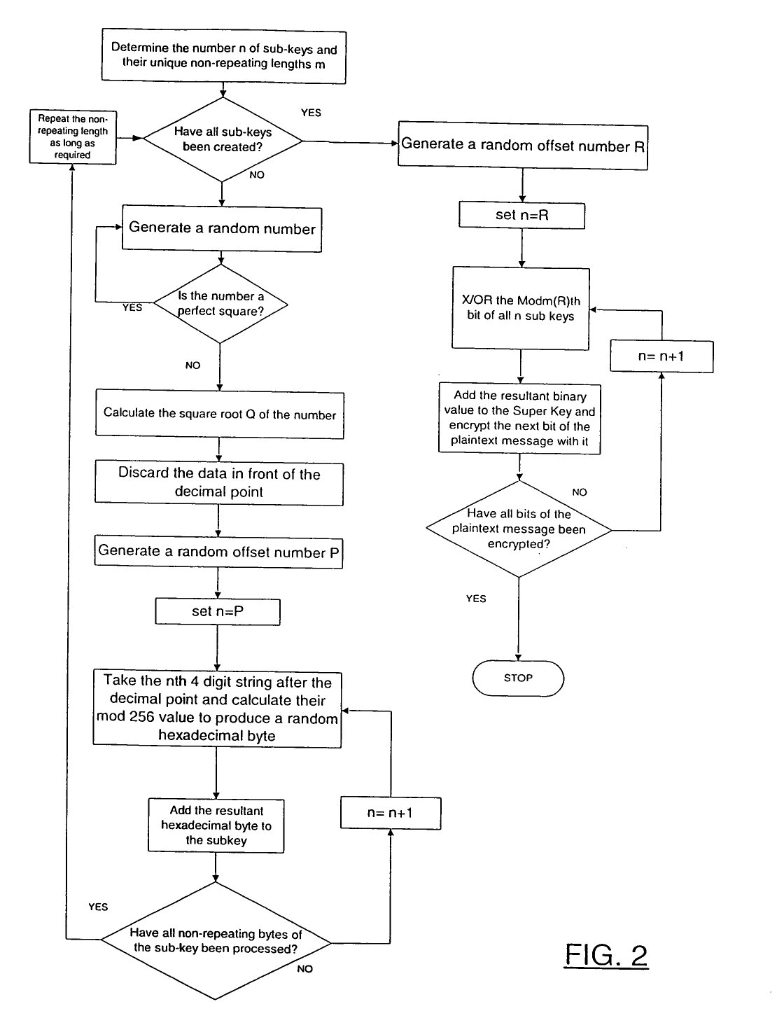

FIG. 2 illustrates by way of a flowchart the method of generating the encryption key of the present invention. In particular an encryption key, a non-repeating stream cipher of indefinite length referred to herein as the Super Key, is formed by combining sub-keys. Any number n of sub keys K₁, K₂, . . . , Kₙ can be specified depending on the application. The greater the number of sub-keys, the greater the length of the non-repeating Super Key. The length of each sub key is a prime number of bytes (preferably with prime numbers larger than 10).

The first step in the process is to determine how large a Super Key, or stream cipher, to deploy. The number n of sub-keys and the non-repeating length mₙ of each sub-key, in bytes, are selected. The sub-keys each have a unique non-repeating length, that is, no two sub-keys are of the same non-repeating length. Preferably the sub-key non-repeating lengths are prime numbers of bytes. Preferably the length of the sub-keys, in bytes, are prime numbers in the range 2, 3, 5, . . . , 16000, as there are 1862 different prime numbers in this range. The selection may be done by manually entering the number of sub-keys and their prime number non-repeating lengths. Alternatively, the number of keys and their prime number non-repeating lengths is programmed into an application, or a program randomly selects the number of sub-keys and their non-repeating length. For n sub-keys Kₙ, the non-repeating length of the Super Key will be Size (K₁)×Size (K₂)×Size (K₃) . . . ×Size (Kₙ). For example, assume 10 sub-keys of the following prime number non-repeating lengths are used:

Sub Key 1=13 bytes=K₁

Sub Key 2=17 bytes=K₂

Sub Key 3=19 bytes=K₃

Sub Key 4=23 bytes=K₄

Sub Key 5=29 bytes=K₅

Sub Key 6=31 bytes=K₆

Sub Key 7=37 bytes=K₇

Sub Key 8=41 bytes=K₈

Sub Key 9=43 bytes=K₉

Sub Key 10=47 bytes=K₁₀

The resulting non-repeating Super Key length is 13×17×19×23×29×31×37×41×43×47=266,186,053,068,611 bytes. Thus, using a small number of sub-keys, each of small prime number non-repeating length results in an extremely long non-repeating Super Key. The total definition for the size of the Super Key above is contained in 300 bytes (the sum of the lengths of the non-repeating sub-keys) and the header (number of sub-keys and their lengths). Thus the total definition for a Super Key will be a fraction of the size of the Super Key.

While preferably the non-repeating length of each sub-key is a prime number of bytes, to improve the randomness of the resulting cipher, the method will also work if non-prime number lengths are used, as long as the resulting cipher is very large.

To select the number of sub-keys, preferably this is calculated by taking the first two digits generated by a random stream, MODed by 20 and adding 11 to provide a number of keys between 11 and 30. Each sub-key of the multi-key process may be created as follows. First a random number which is not a perfect square is generated, preferably by a highly random source. Preferably it is an integer in the range of 500 to 700 digits. This serves as a “first seed value” O. It is verified that the selected value O is not a perfect square. If it is, then additional random values will be generated until one meets this criterion. The second seed value is a 32-bit value that is used to seed the rand function of the computer. Random number generators that are included in the operating systems of most computers are pseudo-random and not very robust. These values, however, are sufficient as a starting point. The second random number P is also generated from the computer's rand function. It is then MODed by 100 to set the starting point. The square root Q of the first seed value O is calculated, resulting in an irrational number Q (one that extends infinitely after the decimal point and is non-repeating). The resultant string of digits after the decimal point is potentially infinite in length and is highly random. The computer discards the digits in front of the decimal and computes the number Q up to P digits after the decimal. Then, starting at the Pth digit of Q after the decimal point, the computer sequentially selects 4 digits at a time, and calculates the Mod 256 value of the 4 digits. This results in an 8-bit value. This value is used as the first byte of the sub-key. This process is repeated 4 digits at a time, continuing with the next digits in sequence, until a string of random data equal to the prime number non-repeating length of the sub-key being created is completed. This process is repeated for all the sub keys until the non-repeating length for all the sub keys are created. Each sub-key then is formed by taking the non-repeating string of bytes thus created, and repeating it as often as necessary to form a sub-key of sufficient length to create the Super Key in combination with the other sub-keys.

The algorithm for generating the sub-keys can be described as follows:

1. Treat seed1 as the decimal representation of an integer in the range of 500-700 digits.

2. Let X:=seed1

3. Let Y:=\sqrt{X} is the irrational number generated by square rooting X

4. Let Z₁, Z₂, Z₃, Z₄, . . . be the digits after the decimal point in the decimal representation of Y. Each Zᵢ is in the range 0, . . . , 9.

5. Call srand(seed2).// only the first time

6. Call rand( ) to get the irrational starting point, start.

7. Let start :=rand( ) mod 100. start is in the range 0,1, . . . , 99.

8. Throw away Z_{1 and Z}₂ all the way to Zₛₜₐᵣₜ.

9. Let tmp :=10*Z₍ₛₜₐᵣₜ₊₁₎+Z₍ₛₜₐᵣₜ₊₂₎. Throw away those used values.

10. Let n :=11+(tmp mod 20). n is in the range 11, 12, . . . , 30.

11. For i :=1,2, . . . , 10, do:

12. Let j=4*(i−1)

13. Let tmp be the next byte from the Z stream.

14. Let tmp :=1000*Zⱼ₊₁+100*Zⱼ₊₂+10Zⱼ₊₃+Zⱼ₊₄

15. Let t :=1862−(tmp mod 1862). t is in the range 1,2, . . . , 1862.

16. Let u be the t^{th} prime among the sequence 2,3,5, . . . , 1862.

17. If u is equal to any of 1¹, 1², . . . , 1^{{i-1}}, set t to (t+1)mod 1862 goto 16

18. Set 1ⁱ=u.

19. Next I: goto 11 until all 10 subkey sizes are set.

20. Then get remainder of lengths

21. For i :=11, . . . , n, do:

22. Let j=5*(i−1)

23. Let tmp be the next byte from the Z stream.

24. Let tmp :=10000*Zⱼ₊₁+1000*Zⱼ₊₂+100Zⱼ₊₃+10*Zⱼ₊₄+Zⱼ₊₅

25. Let t :=16000−(tmp mod 16000). t is in the range 1,2, . . . , 16000.

26. Let u be the t.

27. If u is divisible by any of 1¹, 1², . . . , 1^{{i-1}}, set t to (t+1)mod 16000 goto 26

28. Set 1ⁱ=u.

29. Next I: goto 21 until all subkey sizes are set.

30. For i :=1,2, . . . , n, do:

31. For j :=0,1,2, . . . , 1ⁱ, do:

32. Let k :=4*j

33. Let tmp be the next byte from the Z stream.

34. Let tmp :=(1000*Zₖ+100*Zₖ₊₁+10*Zₖ₊₂+Zₖ₊₃) mod 256

35. Let sⁱⱼ:=tmp

36. Next j: Next subkey byte

37. Next I: Next subkey

38. For i :=0,1,2, . . . , 65535, do:

39. Let j :=4*i

40. Let tmp :=(1000*Zⱼ+100*Zⱼ₊₁+10*Zⱼ₊₂+Zⱼ₊₃) mod 256

41. If tmp is equal to any of S[0], S[1], . . . , S[i−1], set to (tmp+1)mod 256 goto 41

42. Set S[i]:=tmp.

43. Next i

44. Let offset :=ZᵢZᵢ₊₁ . . . Zᵢ₊₉

45. Return n, (1¹,1², . . . , 1ⁿ), (s¹, s², . . . , sⁿ), S[65536] and offset.

46. Save in keyfile and add seed1 and start value to DB

47. Increment seed1 and goto 2 //repeat until enough keys are created

Once all the sub-keys are created as above, the Super Key (cipher) is created to the length required. This means the Super Key will continue to be created to encrypt the associated data to be encrypted, and continues to be created only until all the data is encrypted. First a random number R (“third seed value”, or the starting offset for the Super Key, as opposed to the starting point P for the number Q) is generated. Starting with any one of the n sub-keys, having length mₙ, the Modmₙ of R is calculated and the Modmₙ(R)th byte of each sub-key is consecutively exclusive-or'd (X/OR'd) with the corresponding Modmₙ(R)th byte of every other sub-key. For example, if R=100, and the length of the first sub-key is 97 bytes and the second sub-key 43 bytes, then the 3rd byte of sub-key 1 is selected and X|OR'd with the 14^{th} byte of sub-key 2 and corresponding bytes of the other remaining sub-keys selected in the same way based on R. The process is repeated until all the selected bytes from each sub-key have been X/OR'd. The resulting value may then be put through a substitution cipher or another delinearization function to delinearize the Super Key stream, as described further below. The resultant binary value is then added to the Super Key by concatenation. The next, subsequent byte of sub-key 1 is then X|OR'd with the next byte of sub-key 2 and so on. Again the process is repeated until all the selected bytes from each sub-key have been X/OR'd and delinearized. The resulting binary value of each function is again added to the Super Key by concatenation. While the X/OR function is preferred, it will be apparent that other functions can be applied. For example, mathematical functions of addition or subtraction can be used. As each byte of the Super Key is generated, the corresponding byte of the plaintext message is then encrypted with the corresponding byte of the Super Key by the exclusive-or function or some other mathematical function. Once all the bytes of the plaintext message have been encrypted the generation of the Super Key terminates. The encrypted message can then be decrypted applying the inverse of the encrypting function to it and the Super Key.

To illustrate further the generation of the Super Key from the sub-keys, let Sⱼ^{{i}} denote the j-th byte of the i-th “sub key”. Let l^{{i}} denote the length of the i-th sub-key. For example, we might have l^{{l}}=13, l^{{2}}=17, and so on. Create from the “sub key” i the unending sequence of bytes s₀^{{i}}, s₁^{{i}}, s₂^{{i}}, . . . , s_{l{i}}^{{i}}, s₀^{{i}}, s₁^{{i}} . . .

Let sⱼ^{{i}} denote the j-th byte of the above sequence, if j is any natural number 0 to ∞; the lowest value of j in the subscript of sⱼ^{{i}} is Rmodulo l^{{i}} where R is a random number. Then, thej-th byte of the “Super Key,” call it Zⱼ, is defined by

z₁=sⱼ^{{l}}⊕sⱼ^{{2}}⊕ . . . ⊕sⱼ^{{n}}

Here, “⊕” denotes the XOR operation. The first byte of the Super Key is: z₁=s_{R mod l}_{^{{i}}}^{{1}}⊕s_{R mod l}^{_{{2}}}^{{2}}⊕ . . . ⊕s_{R mod l}^{_{{n}}}^{{n}}

Where Rmod l^{{i}} returns an integer in the range 0,1,2, . . . , (l^{{i}}−1)

The “SuperKey” has a j value that ranges from 0 to

((l^{{1}}×l^{{2}}×l^{{3}} . . . l^{{n}})−1)

Let P₀,P₁,P₂,P₃, . . . be the bytes of the plaintext, and C₀,C₁, . . . the bytes of the ciphertext, in order. Also, z₀,z₁, . . . denotes the bytes of the “Super Key” (computed as already described above). A Substitution step is used to de-linearize the above stream. This is done by having a Substitution using two bytes of the Superkey stream that are used to index the full 65536 array. This array is a random scrambling of values 0 to 255, 256 of each value.

The ciphertext is defined by Cᵢ:=Pᵢ xor S[zᵢ]. The ciphertext C is formed by concatenating the bytes C₀,C₁, . . . , and then C is returned as the result of the encryption process. Decryption works in reverse in the obvious manner.

To encrypt an L-byte plaintext, an L-byte Super Key is generated, and a big number counter T is used to count the number of bytes in the plaintext P. The counter T is set during key creation for the first message, then incremented by the size of the plaintext for the next message, and so on for the third message, etc. The output is an L-byte ciphertext C which is the encryption of P. To decrypt the ciphertext C, the same big number counter T is used and the output is the L-byte plaintext P.

In order to reduce the linearity of the ciphertext using the present method, a further step may be applied to the Super Key before the plaintext message is encrypted. In one embodiment, a substitution cipher is applied to the Super Key, and the resultant string is then used to encrypt the plaintext message. For example, an array of 256 unique bytes is created, from 1 to 256 ordered randomly. The first byte in the Super Key then has substituted for it the value of the x+1 st byte in the Super Key, where x is the first value in the 256 byte array. The second byte in the Super Key then has substituted for it the value of the y+2nd byte in the Super Key, where y is the second value in the 256 byte array, and so on. The 256-byte array can be formed from one of the sub-keys, plugging in bytes from a sub-key into the array so long as they don't repeat a previous entry in the array.

The foregoing method using a substitution cipher on the resulting key stream may be modified as follows to further reduce linearity. The key stream may also be put through a 2 byte substitution cipher that returns only 1 byte which is then used to randomize the plaintext. According to this embodiment, an array of 65536 bytes is created, from 1 to 256 ordered randomly. The first byte in the Super Key then has substituted for it the value of the z+1st byte in the Super Key, where z=[X xor Y], and X is the first value in the 65536 array and Y is the second. The second byte in the Super Key then has substituted for it the value of the a+2nd byte in the Super Key, where a=[B xor C] and B and C are the third and fourth values in the 65536 byte array, and so on. The 65536 array can be formed from one of the sub-keys, plugging in bytes from a sub-key into the array so long as they don't repeat a previous entry in the array.

As a further alternative to the 256 byte substitution cipher delinearization method noted above, a 65536 byte substitution cipher array may be used. Each location in the array has a value between 0 and 256, equally and randomly distributed, so that each value occurs 256 times in the array. This substitution cipher is then applied to the Super Key in the same way, and the resultant string is then used to encrypt the plaintext message. That is, the first byte in the Super Key then has substituted for it the value of the x+1st byte in the Super Key, where x is the first value in the 65536 byte array. The second byte in the Super Key then has substituted for it the value of the y+2nd byte in the Super Key, where y is the second value in the 65536 byte array, and so on. The result is delinearized since the substitution values repeat in a random way in the array.

The linearity of the cipher text can be reduced also by applying the substitution cipher to the encrypted message (ciphertext) however it is more effective to apply the substitution cipher to the Super Key prior to encrypting. Other utilities besides a substitution cipher can be used to break linearity, such as invertible non-linear function (INLF) utilities available from SANDIA labs. These are useful to provide protection against the Berlekamp-Massey attack.

According to another embodiment, a second Super Key stream cipher can be used to perform the delinearization. Call the initial stream cipher generated from the method described above, that is the output from X/Oring a first set of subkeys, the Source Stream, and call the second, delinearizing stream cipher used to delinearize the Source Stream, generated from the method described above, that is the output from X/Oring a second set of subkeys, the Offset Stream. Both streams have random offset starting points. The Delinearized Stream cipher is generated by this process.

The first byte, the initial random offset of the Source Stream, drops down to form the first byte of the Delinearized Stream. The next byte value of the Delinearized Stream is then generated by moving along the Source Stream a number of bytes based on the first byte of the Offset Stream plus 1 (to avoid using the same byte of the Source Stream if the value of the Offset Stream is 0). The next byte value of the Delinearized Stream is then generated by moving along the Source Stream a further number of bytes based on the second byte of the Offset Stream plus 1, and so on, incrementing the offset byte of the Offset stream by one for each substitution. The process is repeated until the delinearized stream of desired or necessary length is completed.

According to another embodiment the delinearization is accomplished during the generation of the stream cipher from the subkeys, by using the previous subkey's next byte added to the offset of the current subkey. This causes a random shift to each subkey, thereby removing linearity. That is, during the generation of the stream cipher, when applying the xor function to all n bytes of the sub-keys to generate a value, the position of the byte of each sub-keys to which the function is applied is selected by using the previous subkey's next byte and adding it to the offset of the current subkey.

In this embodiment, the delinearization of the stream cipher output is achieved during the creation of the Super Key, rather than by running each bit of the Super Key (stream cipher) through a substitution array as described above. In this iteration, the value of the byte adjacent to the being processed on a particular key stream is used to offset or jump along the next subsequent subkey by a random amount to the position of the byte in the next subkey to be x-or'd. The process starts at the initial offset on the first subkey, with its random sequence repeated over and over. This first byte is selected, while noting the value of the adjacent byte to it on subkey stream. This first byte is x-or'd not with the corresponding byte of subkey 2, but rather the byte in subkey 2 (“the third byte”) which is further offset by the value of the adjacent byte to the first byte in subkey 1. That value is then x-or'd with the byte in subkey 3 which is further offset by the value of the byte adjacent to the third byte in subkey 2, and so on until a byte in each subkey has been x-or'd. The resulting output of this x-or then becomes the first byte of the delinearized stream cipher which is used to encrypt the plaintext in the subsequent step. This process is then repeated with the subsequent bytes until a delinearized stream cipher (Super Key) of the desired or necessary length is created.

While preferably the random non-repeating string which forms each sub-key is generated as described above, the method will also work if the non-repeating string of each sub-key is simply generated by a random number generator to form each sub-key, as long as the overall resultant length of the Super Key is sufficiently large so that the resultant Super Key is at least double the size of the data to be encrypted.

The foregoing method can be used to produce a personal security system whereby the key is used to encrypt personal files that the user wishes to secure. In that case no method of distribution of the key will be required. As each file is encrypted a new file named {OLDFILENAME}.wn is created which has a small header added to handle versions and different keys. The OLDFILENAME includes the extension to allow for easy decryption and maintaining the same file format for functionality. As each file is encrypted, it is immediately decrypted and compared to the original and then both the test copy and the original file are deleted using a clean sweep deletion process (entire file rewritten as 0's and then 1's and then deleted).

A preferred key file format is defined as follows:

typedef struct wnkeyfiletype {

char field[2]; // must be WN to identify file format
long version; // file type version number to allow changes
BIGNUMBER offset; // the offset is a large number stored as a
// string of decimal digits delineated by “”’s
long numsk; // the number of subkeys
long sklen[numsk]; // the individual subkey lengths
char sk1[sklen[1]]; // the 1^{st} subkey
char sk1[sklen[2]]; // the 2^{nd} subkey
char sk1[sklen[3]]; // the 3^{rd} subkey

... ... ... ...

char sknumsk[sklen[numsk]]; // the numsk^{th} subkey
char substit[65536]; // the substitution cipher key

} WNKEYFILE;

The foregoing key file format is generally standard. The only different value is the offset that is stored in a string of decimal digits that are delineated by “'s. An example of this would be “987654321”, this allows for values ranging up to 1000 digits long which prevents the reuse of sections of the key stream if the offset is implemented properly.

The present invention is described above as a computer-implemented method. It may also be embodied as a computer hardware apparatus, computer software code or a combination of same. The invention may also be embodied as a computer-readable storage medium embodying code for implementing the invention. Such storage medium may be magnetic or optical, hard or floppy disk, CD-ROM, firmware or other storage media. The invention may also be embodied on a computer readable modulated carrier signal. As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of generating a stream cipher having length×bytes, the method comprising the steps of:
i) selecting a number n of sub-keys each having a unique non-repeating length mₙ bytes;
ii) generating n random numbers, one for each sub-key, each having length mₙ bytes;
iii) generating a n+1st random number R;
iv) set p=Modmₙ(R);
v) for each byte whose position in said nth random number is p applying a function to all n bytes to generate a value;
vi) concatenating said value to the end of said stream cipher;
vii) set p=p+1; and
viii) repeating step v), vi) and vii) until said stream cipher is x bytes in length.

2. The method of claim 1 wherein said selected length mₙ of each said sub-key is a prime number.

3. The method of claim 1 wherein said selected length mₙ of each said sub-key is a prime number greater than 10.

4. The method of claim 1 wherein said function applied to said n bytes of said sub-keys is the exclusive-or function.

5. The method of claim 1 comprising the further step of applying a delinearization function to said stream cipher.

6. The method of claim 5 wherein said delinearization function is a substitution cipher.

7. The method of claim 1 wherein each of said n random numbers are generated by:
i) generating a n+2nd random number which is not a perfect square;
ii) calculating the square root of said n+2nd random number;
iii) generating a n+3rd random number;
iv) commencing with a digit whose position in said n+2nd random number is calculated based on said n+3rd random number, taking finite strings of digits sequentially and converting each said finite string into a byte;
v) concatenating each byte sequentially until the selected length mₙ of said each of said n random numbers has been reached.

8. The method of claim 7 wherein said finite strings of digits are at least 4 digits long.

9. The method of claim 8 wherein said finite string is converted into a byte by applying a mod function.

10. The method of claim 7 wherein said finite string is converted into a byte by applying a mod 256 function.

11. A computer program product for generating a stream cipher having length×bytes, said computer program product comprising a computer usable medium having computer readable program code means embodied in said medium for:
i) selecting a number n of sub-keys each having a unique non-repeating length mₙ bytes;
ii) generating n random numbers, one for each sub-key, each having length mₙ bytes;
iii) generating a n+1 st random number R;
iv) set p=Modmₙ(R);
v) for each byte whose position in said nth random number is p applying a function to all n bytes to generate a value;
vi) concatenating said value to the end of said stream cipher;
vii) set p=p+1; and
viii) repeating step v), vi) and vii) until said stream cipher is x bytes in length.

12. The computer program product of claim 11 wherein said selected length mₙ of each said sub-key is a prime number.

13. The computer program product of claim 11 wherein said selected length mₙ of each said sub-key is a prime number greater than 10.

14. The computer program product of claim 11 wherein said function applied to said n bytes of said sub-keys is the exclusive-or function.

15. The computer program product of claim 11 wherein said computer usable medium has computer readable program code means embodied in said medium for the further step of applying a delinearization function to said stream cipher.

16. The computer program product of claim 15 wherein said delinearization function is a substitution cipher.

17. The computer program product of claim 11 wherein each of said n random numbers is generated by:
i) generating a n+2nd random number which is not a perfect square;
ii) calculating the square root of said n+2nd random number;
iii) generating a n+3rd random number;
iv) commencing with a digit whose position in said n+2nd random number is calculated based on said n+3rd random number, taking finite strings of digits sequentially and converting each said finite string into a byte;
v) concatenating each byte sequentially until the selected length mn of said each of said n random numbers has been reached.

18. The computer program product of claim 13 wherein said finite strings of digits are at least 4 digits long.

19. The computer program product of claim 14 wherein said finite string is converted into a byte by applying a mod function.

20. The method of claim 5 wherein said delinearization function is a substitution cipher comprising an array of random values and in which a function is applied to two of said random values in said array to provide a substitution value.

21. The method of claim 5 wherein said delinearization function utilizes a substitution cipher comprising an array in which the values in the array are randomly repeated.

22. The method of claim 5 wherein said delinearization function utilizes a second stream cipher as a substitution cipher.

23. The method of claim 1 wherein a delinearization step is carried out during the generation of the stream cipher wherein, when applying a function to all n bytes of the sub-keys to generate a value, the position of the byte of each sub-keys to which the function is applied is selected by using the previous subkey's next byte and adding it to the offset of the current subkey.
